(19) United States
(12) Patent Application Publication
(10) Pub. No.: US 2017/0168982 A1
(43) Pub. Date: Jun. 15, 2017

(54) METHOD AND SYSTEM FOR TRANSMITTING USB SIGNAL BASED ON FFC

(71) Applicants: Le Holdings (Beijing) Co., Ltd., Beijing (CN); Le Shi Zhi Xin Electronic Technology (Tianjin) Limited, Tianjin (CN)

(72) Inventor: Qi CHANG, Tianjin (CN)

(21) Appl. No.: 15/250,804

(22) Filed: Aug. 29, 2016

Related U.S. Application Data
(63) Continuation of application No. PCT/CN2016/088571, filed on Jul. 5, 2016.

(30) Foreign Application Priority Data
Dec. 14, 2015 (CN) 201510943966.3

(51) Int. Cl. G06F 13/42; G06F 13/38

(52) U.S. Cl. CPC G06F 13/4286; G06F 13/385

(57) ABSTRACT

A method and system for transmitting a USB signal based on an FFC are disclosed. The method includes: presetting an FFC combination between a host and a device, the FFC combination including multiple FFCs as well as a first-stage USB signal compensator and a second-stage USB signal compensator for connecting the FFCs; and when a USB signal is transmitted between the host and the device, amplifying the USB signal by the first-stage USB signal compensator, and adjusting by the second-stage USB signal compensator the amplified USB signal to satisfy the requirements of the device. Long-distance transmission of a USB signal by using an FFC is realized according to the embodiments of the present disclosure.

### CROSS REFERENCE TO RELATED APPLICATIONS

This application is a continuation of PCT Application No. PCT/CN2016/088571 filed on Jul. 5, 2016, which claims priority to Chinese Patent Application No. 2015109439663, filed before State Intellectual Property Office of the P. R. China on De. 14, 2015 and entitled “METHOD AND SYSTEM FOR TRANSMITTING USB SIGNAL BASED ON FFC”, the entire contents of which are incorporated herein by reference.

### TECHNICAL FIELD

The present disclosure relates to the field of signal transmission technologies, and more particularly, to a method and system for transmitting a USB signal based on an FFC.

### BACKGROUND

A bus is a group of transmission lines for transferring information from one or more source parts to one or more target parts. Generally speaking, a bus is a common connection line between multiple parts and is used for transmitting information between the parts.

A universal serial bus (USB) is a serial bus standard that connects a computer system and an external apparatus, and is also a technical specification of an input/output (I/O) interface. The USB is widely applied in information communication products such as personal computers and mobile apparatuses, and is extended to other related fields such as photographic equipment, digital televisions (set-top boxes) and game consoles. Since the emergence of the USB, this interface is widely applied in existing electronic products due to characteristics that it is easy and convenient to use, supports hot-swapping, and has a high speed. The USB is considered as the most successful I/O interface technique on a PC platform, and also becomes a standard interface for mobile phones, digital cameras, printers and various types of consumer electronic products besides PCs and peripherals.

The USB specification evolves from USB 1.0 Low Speed and USB 1.1 Full Speed standards of the first generation to USB 2.0 High Speed standard after years of development, and the transmission rate reaches 480 Mb/s, but taking problems such as the protocol overhead and interface performance of the bus into consideration, the actually optimized transmission speed may only reach 20-30 MB/s at the most. Due to the development of the computer performance and peripheral techniques as well as requirements of high-definition video transmission and large-capacity data storage, the transmission speed of USB2.0 gradually becomes a bottleneck. Therefore, the USB organization released the USB 3.0 specification at the end of 2008, the signal rate of a bus reaches 5 Gb/s, and the actual data throughput rate may reach above 200 MB/s.

Currently, in the design of a USB interface of a television, a USB signal is generally transmitted by using a flexible flat cable (FFC). As illustrated in FIG. 1, the FFC is a new data cable fabricated by press-fitting on a high-tech automation equipment production line using a PET insulating material and an ultra-thin tinned flat copper wire, and has advantages such as being flexible; capable of being bent and folded at random; thin, small in size, simple in connection and convenient to disassemble; and capable of solving the problem of electromagnetic shielding easily. Besides, the number and pitch of wires in an FFC may be selected at random, so the connection is more convenient, the size of electronic products is largely reduced, the production cost is lowered, and the production efficiency is improved. The FFC is most suitable for being used as a data transmission cable between a mobile part and a mainboard, between PCB boards, and in small-sized electrical apparatuses.

The technical parameters of an FFC mainly include: conductor number N, indicating the number of copper wire conductors in the flat cable; pitch P, indicating a distance between the center lines of two adjacent conductors; margin M, indicating a distance between the center line of an outermost conductor to the edge of the flat cable; total pitch TP, indicating a distance between the center lines of two outermost conductors, TP=P*(N−1); total width W, indicating a distance between two edges of the flat cable, W=P*(N+1); exposure length, indicating the average length of exposed conductors in a longitudinal direction; total length TL, indicating a distance between two ends of the flat cable; and terminal thickness TT, indicating the thickness of two connecting terminals of the flat cable.

In the related art, as illustrated in FIG. 2, a USB signal is transmitted between a host and a device through an FFC. However, in the process of transmitting a USB signal through an FFC, the USB signal is attenuated, and the attenuation degree is related to the length of the FFC.

For example, in the actual disclosure, the maximum length of an FFC for transmitting a USB3.0 signal is generally limited to 500 mm, and if the length exceeds 500 mm, a signal failure may likely occur in a transmitted (TX) signal and a received (RX) signal based on USB3.0, and thus the transmission of a USB3.0 signal cannot be realized.

### SUMMARY

The present disclosure provides a method and system for transmitting a USB signal based on flexible flat cable (FFC), which are capable of implementing long-distance transmission of USB signals based on FFC.

An embodiment of the present disclosure provides a method for transmitting a USB signal based on an FFC, including:

presetting an FFC combination between a host and a device, the FFC combination including multiple FFCs as well as a first-stage USB signal compensator and a second-stage USB signal compensator for connecting the FFCs; and

when a USB signal is transmitted between the host and the device, amplifying the USB signal by the first-stage USB signal compensator, and adjusting by the second-stage USB signal compensator the amplified USB signal to satisfy the requirements of the device.

An embodiment of the present disclosure provides a system for transmitting a USB signal based on an FFC, including:

a host, a device, and an FFC combination for connecting the host and the device, wherein

the FFC combination includes multiple FFCs as well as a first-stage USB signal compensator and a second-stage USB signal compensator for connecting the FFCs; and

when a USB signal is transmitted between the host and the device, the first-stage USB signal compensator amplifies the USB signal, and the second-stage USB signal compensator adjusts the amplified USB signal to satisfy the requirements of the device.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a schematic diagram illustrating an FFC in the related art;

FIG. 2 is a schematic diagram illustrating transmission of a USB signal through an FFC in the related art;

FIG. 3 is a schematic diagram illustrating transmission of a USB signal through an FFC according to some specific embodiments of the present disclosure; and

FIG. 4 is a schematic flowchart illustrating a method for transmitting a USB signal based on an FFC according to some specific embodiments of the present disclosure.

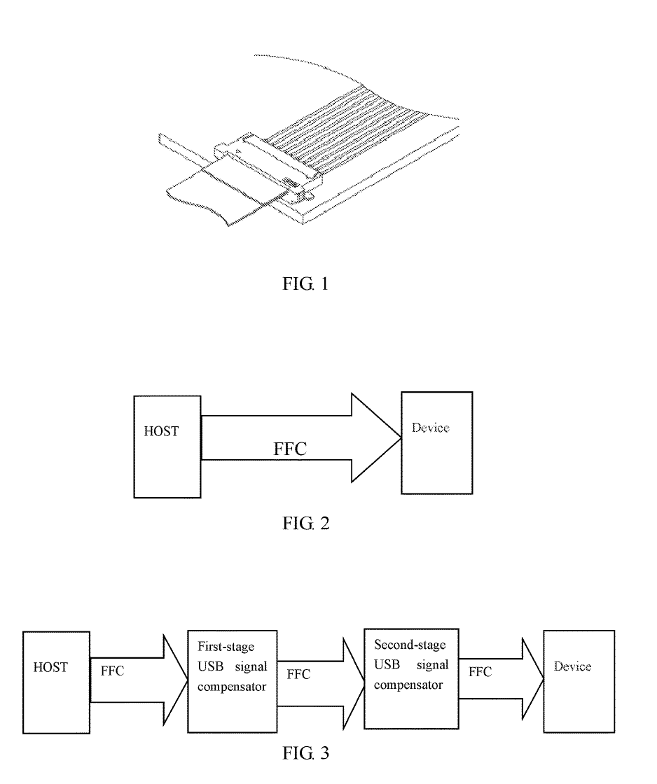

### DETAILED DESCRIPTION

To make the objectives, technical solutions and advantages of the present disclosure clearer, the technical solutions in the embodiments of the present disclosure are described clearly and completely with reference to the accompanying drawings in the embodiments of the present disclosure. Apparently, the described embodiments are merely some of rather than all of the embodiments of the present disclosure. Based on the embodiments of the present disclosure, all other embodiments derived by persons of ordinary skill in the art without any creative efforts shall fall within the protection scope of the present disclosure.

### Embodiment 1

FIG. 3 is a schematic diagram illustrating transmission of a USB signal through an FFC according to a specific embodiment of the present disclosure.

As illustrated in FIG. 3, a USB signal is transmitted between a host and a device through an FFC.

In a specific embodiment of the present disclosure, transmission of a USB3.0 signal is taken as an example for illustration. USB 3.0 is also called a SuperSpeed USB bus, and compared with a high-speed USB bus, to be backward compatible with USB2.0, USB 3.0 maintains USB2.0 signal lines (D+, D−, Vbus, GND), and adds two pairs of USB 3.0 super-speed differential signals (SSTX+, SSTX−, SSRX+, SSRX−) on this basis, wherein one differential pair is used for transmitting signals, and the other differential pair is used for receiving signals, thereby achieving full-duplex transmission; the super-speed signal transmission rate reaches 5 Gbit/s, an 8B/10B coding mechanism is adopted, the maximum current value reaches 900 mA, and a spread spectrum clock (SSC) function is added to reduce the EMI.

USB 3.0 is used as a high-speed transmission interface, signal integrity is a primary problem to be solved in the system design, and attenuation may reduce the quality of signal transmission. Attenuation definitely occurs in the transmission of a USB 3.0 signal by using an FFC, and the attenuation degree is related to the length of the FFC. In the actual disclosure, the maximum length of an FFC for transmitting a USB3.0 signal is generally limited to 500 mm.

In the layout of an electronic product such as a television or display by a user, to make full use of the space, long-distance transmission is needed in some circumstances, and signal integrity is especially important. Consumers wish to use an apparatus at will, for example, assume that a user intends to connect a mobile phone to a television through a cable, the cable at least needs to be two meters long in order to be connected to the back of the television, and thus the user may not feel uncomfortable for being too close to the screen. In actual life, the consumers sometimes may not read the interface specification before buying a cable and only wish the cable can work, and as a result, they may buy a cable that is longer than what is specified by a system or has poor quality and is not good in shielding.

With increase of new disclosures of a portable apparatus, there is an increasing demand for supporting longer and cheaper cables. Although these disclosures may eventually adopt wireless communication, the development has not reached that level yet. For example, when most of the consumers have portable apparatuses that can transmit video streams, only a few televisions provide wireless connection. Therefore, it is an important characteristic to ensure the signal integrity of a cable for the consumers.

Active cables adopting ReDrivers to extend length are increasingly available in the market. The ReDriver is also called a signal repeater (Repeater IC), which can regenerate a signal and improve the signal quality on a high-speed interface. The high-speed signal frequency results in decrease of allowance available in design, increase of design durability and difficulty in a high performance system. By using techniques such as equalization and pre-emphasis, a single ReDriver can be used to adjust and correct loss in a channel on a transmitting end, and recover signal integrity on a receiving end.

The signal conditioning provided by a ReDriver is transparent to a communication channel. The ReDriver does not decode data or evaluate a protocol command, but recovers the initial signal integrity. The parameter of a ReDriver is selected according to channel characteristics, and the ReDriver works independent of other parts of a system. To achieve the optimal performance, the input and output of a ReDriver both need characterization, to match an actual channel where the ReDriver is placed, and in ideal conditions, a high-speed interface should be designed into a closed channel or a restricted open channel. The overall architecture of a system needs to be considered before a ReDriver is placed. For example, for many small-sized apparatuses, the center point of loss may be at the middle position of an additional cable. In this case, the optimal signal conditioning can be realized by placing the ReDriver at a position as close to a connector as possible.

Therefore, the present disclosure provides a solution of adopting a ReDriver to realize long-distance transmission of a USB3.0 signal based on an FFC.

Relative to the related art, in a specific embodiment of the present disclosure, at least two stages of compensators are added between a host and a device, and the compensators may adopt USB ReDriver ICs and are used for compensating attenuation occurring in a USB3.0 signal in an FFC.

As illustrated in FIG. 3, a system for transmitting a USB signal based on an FFC according to an embodiment of the present disclosure includes: a host, a device, and an FFC combination for connecting the host and the device.

The FFC combination includes multiple FFCs as well as a first-stage USB ReDriver IC and a second-stage USB ReDriver IC for connecting the FFCs.

Specifically, the transmission impedance of each FFC is adjusted, and thus the impedance of each FFC is controlled to be 90Ω±15Ω.

The first-stage USB ReDriver IC amplifies a USB signal.

Specifically, equalization, pre-emphasis and de-emphasis of the first-stage USB ReDriver IC are adjusted, and then the first-stage USB ReDriver IC amplifies a USB signal.

The second-stage USB ReDriver IC adjusts the amplified USB signal to satisfy the requirements of the device.

Specifically, equalization, pre-emphasis and de-emphasis of the second-stage USB ReDriver IC are adjusted, and then the second-stage USB ReDriver IC adjusts the amplified USB signal to satisfy the requirements of the device.

The system for transmitting a USB signal based on an FFC according to the embodiment of the present disclosure adopts two stages of USB ReDriver ICs for compensating attenuation of a USB signal, thereby realizing long-distance transmission of the USB signal.

### Embodiment 2

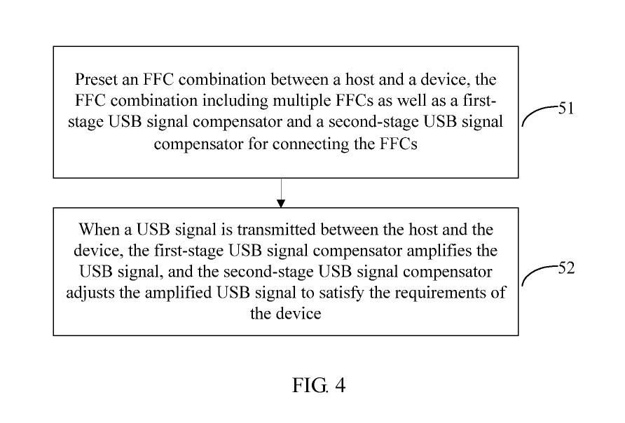

FIG. 4 is a schematic flowchart illustrating a method for transmitting a USB signal based on an FFC according to a specific embodiment of the present disclosure.

As illustrated in FIG. 4, the method includes the following steps:

Step S51: An FFC combination is preset between a host and a device, the FFC combination including multiple FFCs as well as a first-stage USB signal compensator and a second-stage USB signal compensator for connecting the FFCs.

Step S52: When a USB signal is transmitted between the host and the device, the first-stage USB signal compensator amplifies the USB signal, and the second-stage USB signal compensator adjusts the amplified USB signal to satisfy the requirements of the device. Specifically,

the first-stage USB signal compensator and the second-stage USB signal compensator both adopt a USB ReDriver IC.

The step of amplifying the USB signal by the first-stage USB signal compensator includes: adjusting equalization, pre-emphasis and de-emphasis of the first-stage USB signal compensator, and amplifying the USB signal.

The equalization indicates equalization on channel characteristics, that is, an equalizer of a receiving end generates characteristics opposite to the channel characteristics, to compensate intersymbol interference caused by time-varying multipath propagation characteristics of a channel. The equalization technique adopted in the embodiment of the present disclosure is a continuous timing linear equalizer (CTLE). The CTLE performs gain compensation on a high-frequency part, suppresses low-frequency gains, and compensates link losses, such that the signal-to-noise ratio after processing is increased and the bit error rate of the receiving end is reduced.

The pre-emphasis indicates that before a signal is sent, the high-frequency component of an analog signal is increased appropriately, and after a signal is received, inverse processing is performed on the signal, that is, de-emphasis which means to appropriately attenuate the high-frequency component. Such pre-emphasis and de-emphasis techniques can reduce the impact of high-frequency loss of a signal during transmission.

The step of adjusting by the second-stage USB signal compensator the amplified USB signal to satisfy the requirements of the device includes: adjusting equalization, pre-emphasis and de-emphasis of the second-stage USB signal compensator, and adjusting the amplified USB signal to satisfy the requirements of the device.

In a specific embodiment of the present disclosure, the transmission impedance of the FFC is adjusted, and thus the impedance of the FFC is controlled to be 90±15 ohms.

Therefore, the method for transmitting a USB signal based on an FFC according to the embodiment of the present disclosure adopts an FFC combination, the FFC combination including multiple FFCs as well as a first-stage USB signal compensator and a second-stage USB signal compensator for connecting the FFCs, such that attenuation of a USB signal is compensated by using the two stages of USB signal compensators, thereby realizing long-distance transmission of the USB signal.

Finally, it should be noted that the foregoing embodiments are merely used to illustrate the technical solutions of the present disclosure rather than limiting the technical solutions of the present disclosure. Although the present disclosure is described in detail with reference to the foregoing embodiments, persons of ordinary skill in the art should understand that they may still make modifications to the technical solutions described in the foregoing embodiments, or make equivalent replacements to some of the technical features; however, such modifications or replacements do not cause the essence of the corresponding technical solutions to depart from the spirit and scope of the technical solutions of the embodiments of the present disclosure.

What is claimed is:

1. A method for transmitting a USB signal based on an FFC, applied in a signal transmission system, the method comprising:
presetting an FFC combination between a host and a device, the FFC combination comprising multiple FFCs and a first-stage USB signal compensator and a second-stage USB signal compensator for connecting the FFCs; and
when a USB signal is transmitted between the host and the device, amplifying the USB signal by the first-stage USB signal compensator, and adjusting, by the second-stage USB signal compensator, the amplified USB signal to satisfy the requirements of the device.

2. The method for transmitting a USB signal based on an FFC according to claim 1, wherein the first-stage USB signal compensator and the second-stage USB signal compensator both adopt a USB ReDriver IC.

3. The method for transmitting a USB signal based on an FFC according to claim 1, wherein the impedance of the FFC is controlled to be 90±15 ohms.

4. The method for transmitting a USB signal based on an FFC according to claim 1, wherein the step of amplifying the USB signal by the first-stage USB signal compensator comprises:
adjusting equalization, pre-emphasis and de-emphasis of the first-stage USB signal compensator, and amplifying the USB signal, wherein
the equalization is to adopt a continuous timing linear equalizer (CTLE) to perform gain compensation on a high-frequency part of the USB signal, suppress low-frequency gains, and compensate link losses;
the pre-emphasis is to increase the high-frequency component of the input USB signal; and
the de-emphasis is to reduce the high-frequency component of the USB signal after demodulation.

5. The method for transmitting a USB signal based on an FFC according to claim 4, wherein the step of adjusting by the second-stage USB signal compensator the amplified USB signal to satisfy the requirements of the device comprises:
adjusting equalization, pre-emphasis and de-emphasis of the second-stage USB signal compensator, and adjusting the amplified USB signal to satisfy the requirements of the device.

6. A system for transmitting a USB signal based on an FFC, comprising:
a host, a device, and an FFC combination for connecting the host and the device, wherein
the FFC combination comprises multiple FFCs as well as a first-stage USB ReDriver IC and a second-stage USB ReDriver IC for connecting the FFCs; and
when a USB signal is transmitted between the host and the device, the first-stage USB signal compensator amplifies the USB signal, and the second-stage USB signal compensator adjusts the amplified USB signal to satisfy the requirements of the device.

7. The system for transmitting a USB signal based on an FFC according to claim 6, wherein the first-stage USB signal compensator and the second-stage USB signal compensator both adopt a USB ReDriver IC.

8. The system for transmitting a USB signal based on an FFC according to claim 6, wherein the impedance of the FFC is controlled to be 90±15 ohms.

9. The system for transmitting a USB signal based on an FFC according to claim 6, wherein the first-stage USB signal compensator is specifically configured to:
adjust equalization, pre-emphasis and de-emphasis of the first-stage USB signal compensator, and amplify the USB signal, wherein
the equalization is to adopt a continuous timing linear equalizer to perform gain compensation on a high-frequency part of the USB signal, suppress low-frequency gains, and compensate link losses;
the pre-emphasis is to increase the high-frequency component of the input USB signal; and
the de-emphasis is to reduce the high-frequency component of the USB signal after demodulation.

10. The system for transmitting a USB signal based on an FFC according to claim 9, wherein the second-stage USB signal compensator is specifically configured to:
adjust equalization, pre-emphasis and de-emphasis of the second-stage USB signal compensator, and adjust the amplified USB signal to satisfy the requirements of the device.
